(19) United States
(12) Patent Application Publication
(10) Pub. No.: US 2019/0149782 A1
(43) Pub. Date: May 16, 2019

(54) PROJECTION APPARATUS, FOR CONSTITUTING PROJECTION OF WHOLE CONTENT BY COMBINING PROJECTION OF PLURALITY OF PARTIAL CONTENT, CONTROL METHOD FOR THE SAME, AND PROJECTION SYSTEM

(71) Applicant: CANON KABUSHIKI KAISHA, Tokyo (JP)

(72) Inventor: Makiko Mori, Yokohama-shi (JP)

(21) Appl. No.: 16/181,557

(22) Filed: Nov. 6, 2018

(30) Foreign Application Priority Data
Nov. 10, 2017 (JP) 2017-217510

(51) Int. Cl. H04N 9/31

(52) U.S. Cl. CPC H04N 9/3147; H04N 9/3185

(57) ABSTRACT

A projection apparatus that projects one of a plurality of partial content in order to constitute projection of a whole content, comprises: a communication unit configured to communicate with other projection apparatus; an acquisition unit configured to acquire the plurality of partial content to be used in the projection of the whole content; and a control unit configured to control distribution of the plurality of partial content, based on content attribute information that indicates a combination of the plurality of partial content for constituting the projection of the whole content, and layout information that indicates a combination of a plurality of projection apparatuses for constituting the projection of the whole content, wherein the control unit controls the communication unit to transmit partial content that is to be projected by the other projection apparatus to the other projection apparatus.

### BACKGROUND OF THE INVENTION

### Field of the Invention

The present invention relates to a projection apparatus for constituting projection of whole content by combining projection of a plurality partial content, a control method for the same, and a projection system.

### Description of the Related Art

In recent years, projectors that have media-player functions have received attention as display apparatuses that constitute a digital signage system. By providing a projector with media player functions, it is not necessary to separately install an external media player connected by an HDMI cable or the like in the vicinity of the projector, and the installability to the system is improved. Also, reasons for employing a projector as a display apparatus include, for example, the release of products that can withstand prolonged operation due to the proliferation of laser light sources, and the ease of constituting large-screen digital signage compared with displays.

Known configurations of large screen digital signage that use projectors include those that perform multi-projection. With multi-projection, a single content is displayed as a whole, by arranging projection screens of a plurality of projectors to be joined together, and projecting content (called partial content) to be displayed on each of the projectors. In order to constitute such digital signage, it is necessary to create partial content obtained by dividing a whole content (still image data or moving image data), which is the original content, into areas that will be respectively displayed by the projectors, and to transmit the partial content to the respective projectors.

Japanese Patent Laid-Open No. 2006-284990 discloses a technique in which a PC transmits partial content to the projectors according to position information that associates the projectors with multi-projection display positions, in order to transmit partial content used for multi-projection to the projectors. On the other hand, a technique is known in which each projector provides a web page for use in control to a PC via a web server within the projector, and receives partial content from the PC via of the web page that was provided.

However, Japanese Patent Laid-Open No. 2006-284990 discloses a technique in which it is necessary for a PC to determine the position information of projectors and transmit the appropriate partial content to the projectors, and it is necessary for the PC to have a special up-load application. On the other hand, if a projector receives partial content from the PC via a web page, it is not necessary for the PC to have a special upload application. However, it is necessary for a user to connect to the web pages of the respective projectors, and select and transmit the partial content corresponding to each of the projectors. There are problems with this procedure in that it is complicated for the user, and the configuration of the multi-projection will not be displayed as intended if a mistake is made when selecting the partial content to transmit.

### SUMMARY OF THE INVENTION

The present invention has been made in consideration of the aforementioned problems, and realizes a technique which, in a case of constituting projection of content as a whole by the projection of a plurality of projectors, makes it possible to easily distribute suitable partial content to the respective projectors.

In order to solve the aforementioned problems, one aspect of the present invention provides a projection apparatus that projects one of a plurality of partial content in order to constitute projection of a whole content by combining projection of the plurality of partial content, comprising: a communication unit configured to communicate with other projection apparatus, an acquisition unit configured to acquire the plurality of partial content to be used in the projection of the whole content; and a control unit configured to control distribution of the plurality of partial content, based on content attribute information that indicates a combination of the plurality of partial content for constituting the projection of the whole content, and layout information that indicates a combination of a plurality of projection apparatuses for constituting the projection of the whole content, wherein the control unit controls the communication unit to transmit partial content, out of the plurality of partial content, that is to be projected by the other projection apparatus to the other projection apparatus.

Another aspect of the present invention provides, a control method of a projection apparatus that projects one of a plurality of partial content in order to constitute projection of a whole content by combining projection of the plurality of partial content, and that has a communication unit configured to communicate with other projection apparatus, the method comprising: acquiring the plurality of partial content to be used in the projection of the whole content; and controlling distribution of the plurality of partial content, based on content attribute information that indicates a combination of the plurality of partial content for constituting the projection of the % hole content, and layout information that indicates a combination of a plurality of projection apparatuses for constituting the projection of the whole content, wherein, in the control, the communication unit is controlled to transmit partial content that is to be projected by the other projection apparatus, out of the plurality of partial content, to the other projection apparatus.

Yet another aspect of the present invention provides, a projection system comprising a transmission apparatus and a projection apparatus that projects one of a plurality of partial content in order to constitute projection of a whole content by combining projection of the plurality of partial content, the projection apparatus comprising: a communication unit configured to communicate with the transmission apparatus and other projection apparatus; an acquisition unit configured to acquire the plurality of partial content to be used in the projection of the whole content from the transmission apparatus via the communication unit; and a control unit configured to control distribution of the plurality of partial content, based on content attribute information that indicates a combination of the plurality of partial content for constituting the projection of the whole content, and layout information that indicates a combination of a plurality of projection apparatuses for constituting the projection of the whole content, wherein the control unit controls the communication unit to transmit partial content that is to be projected by the other projection apparatus, out of the plurality of partial content, to the other projection apparatus, and the transmission apparatus comprising: a generation unit configured to generate the plurality of partial content from the whole content, and to generate content attribute information; and a transmission unit configured to transmit the plurality of partial content and the content attribute information to the projection apparatus.

According to the present invention, in the case of constituting projection of content as a whole by the projection of a plurality of projectors, it is possible to easily distribute suitable partial content to the respective projectors.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a diagram schematically showing an example of a configuration of a multi-projection system in a first embodiment.

FIG. 2 is a block diagram showing an example of a functional configuration of a projector and a PC in the first embodiment.

FIG. 3 is a flowchart showing a series of operations according to partial content generation processing in the first embodiment.

FIGS. 4A to 4E are diagrams illustrating an example of screens and the like used in partial content generation processing in the first embodiment.

FIG. 5 is a flowchart showing a series of operations related to projector grouping processing in the first embodiment.

FIGS. 6A to 6C are diagrams illustrating an example of screens and the like used in projector grouping processing in the first embodiment.

FIG. 7 is a diagram showing a signage setting page in the first embodiment.

FIG. 8 is a flowchart showing a series of operations of file adding processing in the first embodiment.

FIG. 9 is a diagram schematically showing an example of a configuration of a multi-projection system in a second embodiment.

FIGS. 10A to 10E are diagrams illustrating an example of screens and the like used in partial content generation processing in the second embodiment.

FIGS. 11A to 11D are diagrams illustrating an example of screens and the like used in grouping processing of the projectors of the second embodiment.

FIG. 12 is a flowchart showing a series of operations related to file adding processing in a third embodiment.

### DESCRIPTION OF THE EMBODIMENTS

### First Embodiment

Below is a detailed description of an exemplary embodiment with reference to the drawings. Note that the following describes one example of a multi-projection system in which a projector serving as a display apparatus and a PC serving as an external apparatus (or a transmission apparatus) are used. However, the present embodiment is not limited to projectors, and can also be applied to other electronic devices that are capable of projection. Such a device may include, for example, a digital camera, a mobile phone such as a smartphone, a gaming device, a tablet terminal, a medical device an in-vehicle device, or the like that has a projection unit. Also, the external apparatus is not limited to a PC, and may include, for example, a digital camera, a mobile phone such as a smartphone, a gaming device, a tablet terminal, a medical device, an in-vehicle device, or the like that is capable of communicating with a projector.

Configuration of the Multi-Projection System

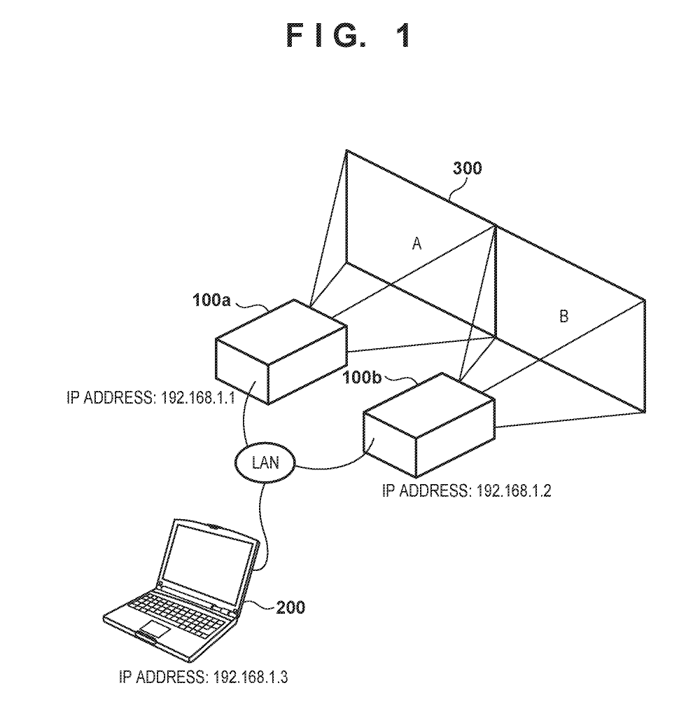

The following describes an example of a configuration of the multi-projection system of embodiments with reference to FIG. 1. Projectors 100a and 100b project partial content for use in multi-projection. A PC 200 generates the partial content to be used in multi-projection and transmits the partial content to predetermined projectors. Note that although content includes image data such as still image data and moving image data, the present embodiment describes an example in which moving image data is used as content.

The projectors 100a and 100b each project their respective images next to one another or with one part overlapping in order to project one image onto a screen 300. Also, the projectors 100a and 100b and the PC 200 are connected in a state in which they can communicate with each other through wired (LAN in the examples in the drawings) or wireless communication, and IP addresses that are illustrated in the drawings, for example, are set in order to identify the apparatuses. Note that, for the sake of simplicity, the following describes a case where multi-projection is performed by using two projectors, but the number of projectors and their arrangement are not limited thereto.

Configuration of the Projector

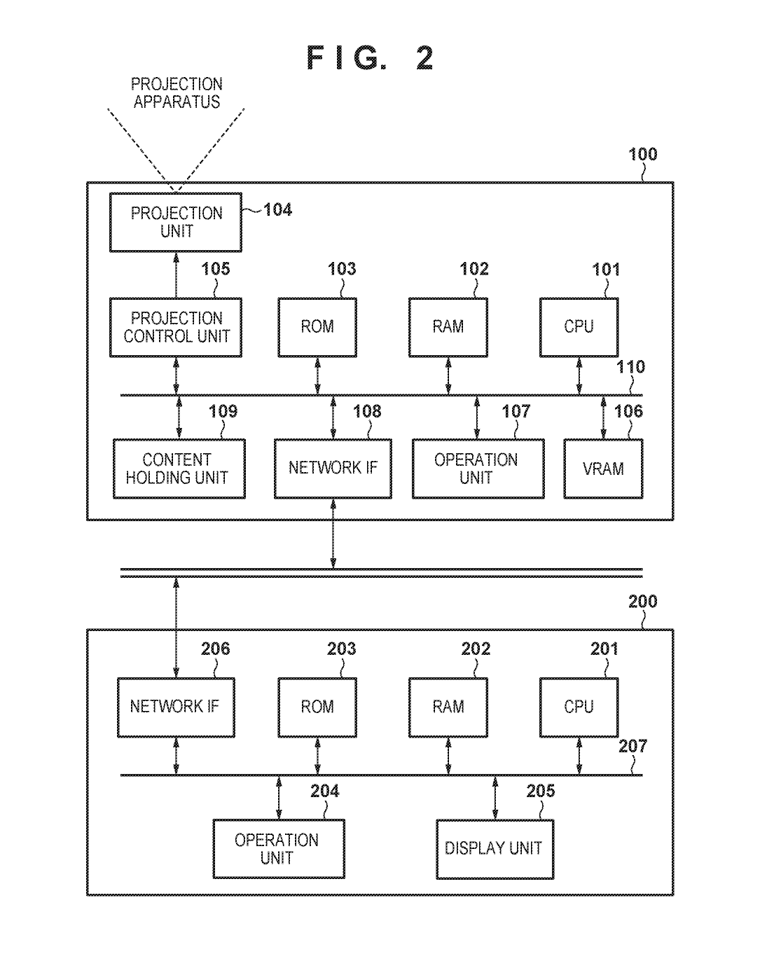

The following describes an example of a functional configuration of the projector 100 and the PC 200 that constitute a multi-projection system, with reference to FIG. 2. Note that the projectors 100a and 100b in FIG. 1 have the same configuration and are thus described as the projector 100.

The projector 100 includes, for example, a CPU 101, a RAM 102, a ROM 103, a projection unit 104, a projection control unit 105, a VRAM 106, an operation unit 107, a network IF 108, and a content holding unit 109. Reference numeral 110 denotes an internal bus that connects the blocks.

The CPU 101 includes one or more processors, and executes processing which will be described later and controls various units of the projector 100, by extracting a control program stored in the ROM 103 to the RAM 102 and executing the control program.

The RAM 102 temporarily stores a control program and data as a work memory of the CPU 101. The ROM 103 records the control program that is executed by the CPU 101 and the various setting values that are used during execution.

The projection unit 104 includes a liquid crystal display (not shown), an optical system (lens) and a light source, for projecting an image instructed by the projection control unit 105, which will be described later. The projection control unit 105 reads out image data that is stored in the VRAM 106 and issues a projection instruction to the projection unit 104. The VRAM 106 is constituted by a semiconductor memory, for example, and provides a recording area for storing images to be projected by the projection unit 104.

The operation unit 107 includes, for example, a switch, a dial or a touch panel, and accepts an instruction from a user and transmits an instruction signal to the CPU 101. Also, the operation unit 107 may receive a signal from a remote controller (not shown), and an instruction signal corresponding to the received signal may be sent to the CPU 101.

The network IF 108 is an interface that performs network communication with an external apparatus, and connects to the PC 200 via a LAN based communication system, for example, and receives data required for multi-projection, such as partial content.

The content holding unit 109 includes a flash memory such as a USB memory or a memory card, for example, and holds content and a content attribute information file, a signage schedule, and the like. An internal device or another external device that can freely delete and write content may be used.

The following further describes the PC 200. The PC 200 of the present embodiment has a CPU 201, a RAM 202, a ROM 203, an operation unit 204, a display unit 205 and a network IF 206. Also, reference numeral 207 denotes an internal bus that connects the above blocks.

The CPU 201 includes one or more processors, and by extracting a control program stored in the ROM 203 to the RAM 202 and executing the control program, executes processing which will be described later, and controls the various units of the PC 200. The RAM 202 temporarily stores the control program and data as a work memory of the CPU 201. The ROM 203 includes a recording medium that records the control program executed by the CPU 201 and the various setting values used during execution.

An operation unit 204 includes, for example, a switch, a mouse, a keyboard or a touch panel, and accepts an instruction from a user and transmits an instruction signal to the CPU 201. A display unit 205 includes, for example, a liquid crystal panel or an organic EL panel, and displays a menu screen and image data according to instructions from the CPU 201. The network IF 206 is an interface that performs network communication with an external device, and connects to the projector 100 via a LAN, for example, and transmits an image, which is partial content.

Partial Content Generation Processing

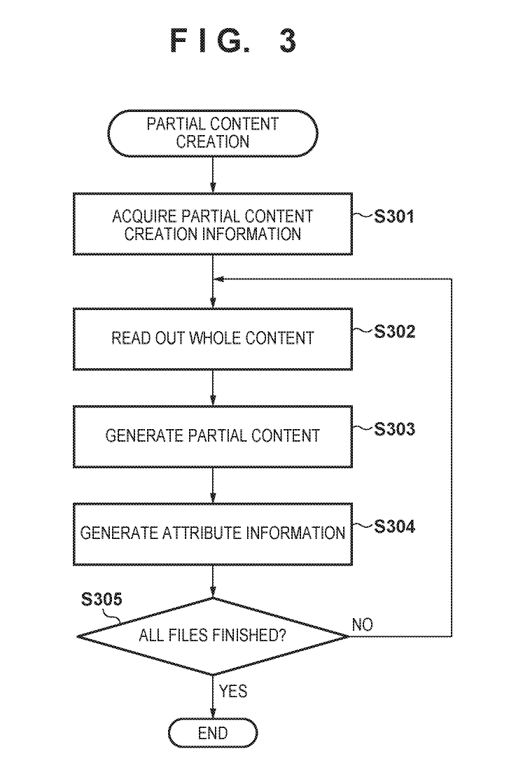

Next, processing for generating partial content for multi-projection, which is executed by the PC 200, will be described with reference to FIG. 3. Note that this processing is realized by the CPU 201 extracting and executing a program recorded in the ROM 203 to a work area of the RAM 202 and executing the program. Also, this processing is started when the user activates an application on the PC 200 for generating partial content.

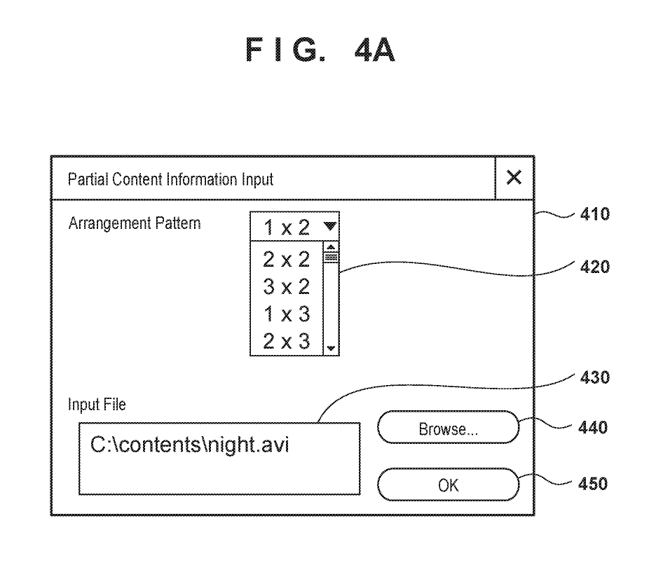

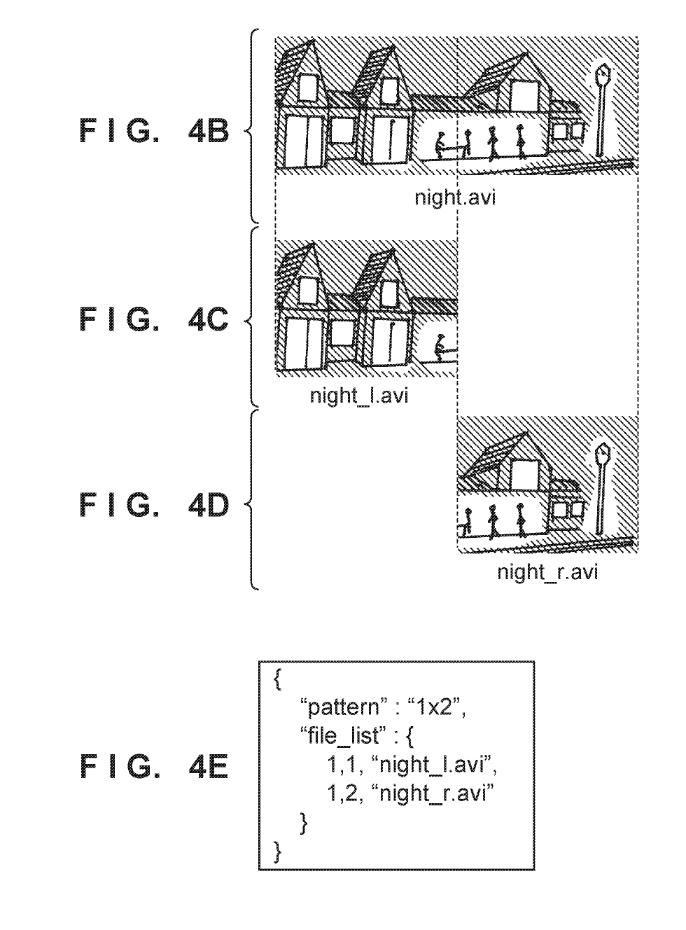

In step S301, the CPU 201 acquires information for generating partial content. Specifically, the CPU 201 displays a partial content information input window on the display unit 205, and acquires user operations on the partial content information input window via the operation unit 204. For example, the CPU 201 displays a partial content information input window 410 shown in FIG. 4A on the display unit 205. In FIG. 4A, reference numeral 420 denotes a pull-down menu for setting the arrangement pattern of the projectors. For example, 1×2 (a layout of two projectors lined up horizontally), 2×2 (a layout of two projectors lined up vertically and two projectors lined up horizontally), 1×3 (a layout of three projectors lined up horizontally) and 3×3 (a layout of three projectors lined up vertically and three projectors lined up horizontally) are selectably displayed. The CPU 201 may read out and display patterns of these selectable layouts, which are pre-recorded on the ROM 103. Of course, the present invention is not limited to the illustrated example, and other layout patterns can be selected by scrolling through the menu.

Reference numeral 430 denotes a file list display unit that is capable of displaying files of content (hereafter referred to as whole content) that is the original content for dividing into partial content in list form. The present invention may be configured such that the user can select any file by clicking a “Browse” button 440, or configured such that the user can drag and drop a target file into the file list display unit 430. There may be one file or a plurality of files that are selectable by the user. The example in FIG. 4A shows that the user has selected “C:¥contents¥night.avi”. Of course, the whole content is not only content that is stored locally on the PC 200, but may be content that is stored in an external apparatus that can be acquired by specifying an URL or the like.

When the user clicks an “OK” button 450, the CPU 201 stores the arrangement pattern and the file list selected by the user in the RAM 202.

In step S302, the CPU 201 reads out the whole content. The CPU 201 reads out the moving image file of the whole content set by the user in step S301 and extracts the moving image file to the RAM 202.

In step S303, the CPU 201 generates partial content. Specifically, the CPU 201, in accordance with the arrangement pattern set in step S301, divides the whole content (night.avi, for example) read out in step S302 to generate partial content files and stores each of the files in the ROM 203. For example, in a case where the displayed example of the whole content is as shown in FIG. 4B, the partial content is, for example, as shown in FIGS. 4C and 4D. That is, FIG. 4C is the partial content for the left hand side projector and FIG. 4D is the partial content for the right hand side projector. Here, because the arrangement pattern is 1×2, the CPU 201 generates the left hand side half of the whole content as, for example, “night_l.avi” and generates the right hand side half of the whole content as, for example, night_r.avi. Here, FIGS. 4B to 4D are, for example, the first frame of a moving image.

In step S304, the CPU 201 generates content attribute information. The CPU 201 generates a file that indicates the attributes of the partial content generated in step S303, and stores the file in the ROM 203. The content attribute information file is generated in text file format, for example. The content attribute information file includes the arrangement pattern set in step S301, an arrangement position in which the partial content is to be projected, and information that specifies the partial content (such as filenames like night_l.avi or night_r.av, URLs, etc.). That is, the content attribute information file includes information on the combination of the partial content for constituting projection of the whole content. FIG. 4E shows an example of the content attribute information file. In this example, first an arrangement pattern of 1×2 is shown as “pattern”. Also, as “file_list”, it is shown that night_l.avi corresponds to the first vertical and first horizontal position, and that night_r.avi corresponds to the first vertical and second horizontal position. The partial content files and the content attribute information file are generated for each whole content selected in step S301. The filenames included in the “file_list” of the content attribute information file are different for each whole content.

In step S305, the CPU 201 determines whether or not partial content and content attribute information have been generated for all of the input files set in step S301. The CPU 201 ends this series of processing if it determines that the generation processing has finished for all of the input files. If processing has not finished for all of the input files, processing returns to S302 for performing the generation processing for the remaining input files.

Note that the storage location of partial content and the content attribute information file may be recorded to a removable recording medium such as a hard disk (not shown) or a USB memory, or may be a file server connected via a LAN, instead of the ROM 203.

Projector Grouping Processing

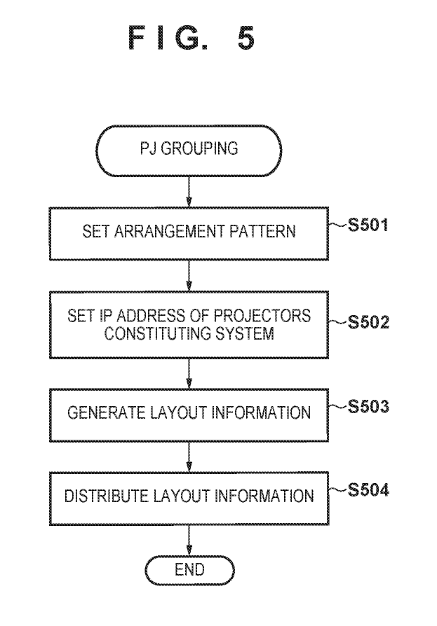

Next, processing for grouping projectors to be used in multi-projection, which is executed by the projector 100, will be described with reference to FIG. 5. This processing is realized by the CPU 101 extracting a program recorded in the ROM 103 to a work area of the RAM 102 and executing the program. Also, this processing starts when the projector grouping processing is selected by the user on the menu screen of the projector 100.

In step S501, the CPU 101 sets the arrangement pattern of the projectors. Specifically, first, the CPU 101 generates an arrangement pattern setting menu and stores the generated menu in the VRAM 106, and the generated menu is projected by the projection unit 104 via the projection control unit 105.

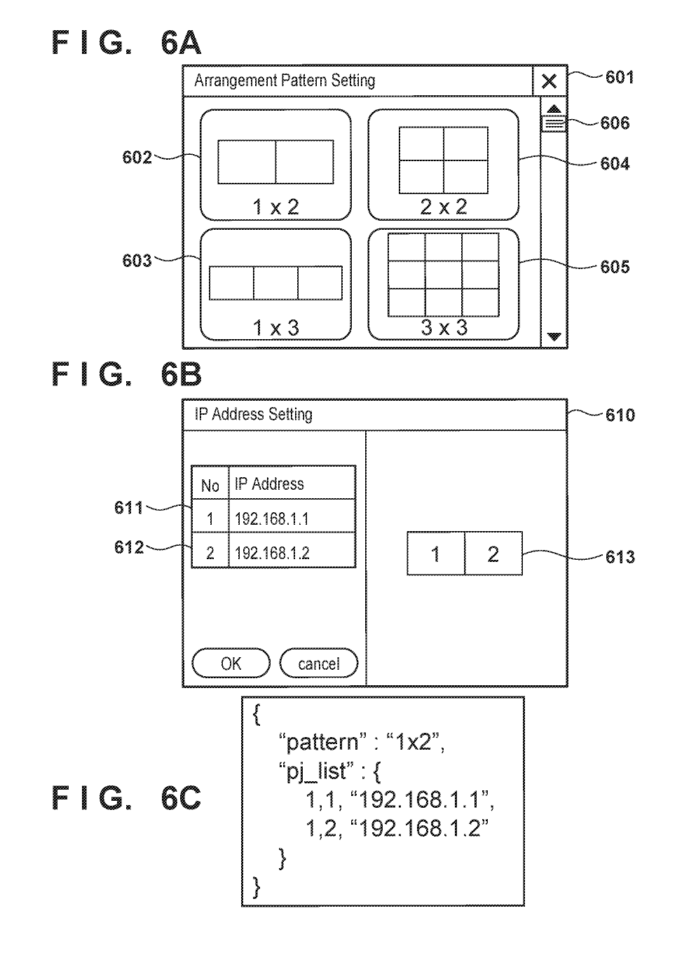

Then, the CPU monitors operations made by the user on the arrangement pattern settings menu 601 via the operation unit 107, and accepts an arrangement pattern setting determined by the user. The arrangement pattern settings menu 601 displays, for example, a plurality of selectable arrangement patterns 602 to 605 as shown in FIG. 6A. In the example in FIG. 6A, 1×2 (a layout of two projectors lined up horizontally), 2×2 (a layout of two projectors lined up vertically and two projectors lined up horizontally), 1×3 (a layout of three projectors lined up horizontally) and 3×3 (a layout of three projectors lined up vertically and three projectors lined up horizontally) are selectably displayed. Furthermore, the user can select a layout other than those displayed by scrolling through the menu with a scroll 606. When a user uses the operation unit 107, such as a remote controller, to select an arrangement pattern, the CPU 101 sets the selected arrangement pattern and stores the selected arrangement pattern in the RAM 102. Here, the user has selected the 1×2 arrangement pattern 602.

In step S502, the CPU 101 sets the IP addresses of the projectors that constitute the multi-projection system. The IP address settings menu 610 is for setting IP addresses and shows the IP addresses 611 and 612 of the plurality of projectors that constitute the arrangement pattern, as shown in FIG. 6B for example. Specifically, the CPU 101 generates a menu screen according to the arrangement pattern set in step S501 and stores the generated menu in the VRAM 106. The CPU instructs the projection control unit 105 to project the menu from the projection unit 104. In the present embodiment, due to the arrangement pattern 1×2 being selected in step S501, the CPU 101 displays the IP addresses 611 and 612 of two projectors in the IP address input fields on the left hand side of the menu screen, as well as displaying the 1×2 arrangement pattern 613. The CPU 101 sets the IP address “192.168.1.1” of the projector 100a as No. 1, and the IP address “192.168.1.2” of the projector 100b as No. 2, both of which were input by the user via the operation unit 107, such as a remote controller.

In step S503, the CPU 101 generates multi-projection layout information. Specifically, the CPU 101 uses the IP addresses and numbers set in step S502 to generate a layout information file (layout generation processing), and stores the generated layout information file in the RAM 102. FIG. 6C shows an example of a layout information file. The layout information includes the type of arrangement pattern, information which identifies the projectors, and the positions where the respective projectors will project. That is, the layout information shows information on the combination of the projectors for constituting projection of the whole content. In the example in FIG. 6C, the arrangement pattern is 1×2, the IP address of the projector in the first vertical and first horizontal position is “192.168.1.1”, and the IP address of the projector in the first vertical and second horizontal position is “192.168.1.2”. Of course, identification information other than an IP address, such as the name of a device that is managed by a URL, a URI, or a DNS, may be used for the information that identifies the projectors.

In step S504, the CPU 101 distributes the layout information to the projectors that constitute the multi-projection system. The CPU 101 transmits the layout information file that was generated in step S503 to all the projectors that were set in step S502 via the network IF 108. If there is no response from a predetermined projector within a fixed period of time, the CPU generates a message dialog (not shown) that informs the user that connection is not possible, stores the message dialogue in the VRAM 106, and instructs the projection control unit 105 to project the message from the projection unit 104. Afterwards, the CPU 101 may attempt to re-transmit the layout information at regular intervals, for example, or may return to step S502 where the IP address may be re-set by the user.

The CPU 101 of the other projectors (the projector 100b, for example), which receives the layout information file, stores the received layout information file in the RAM 102. By doing so, the layout information is shared by all of the projectors that constitute the multi-projection system.

Note that the example above describes an example of using the menu of the projectors themselves to group the projectors. However, the web server of the projector 100a may provide a web page (in other words, display information to be displayed by an application of an external apparatus), and projector grouping settings may be configured from the external apparatus via the web page.

Signage Settings Page

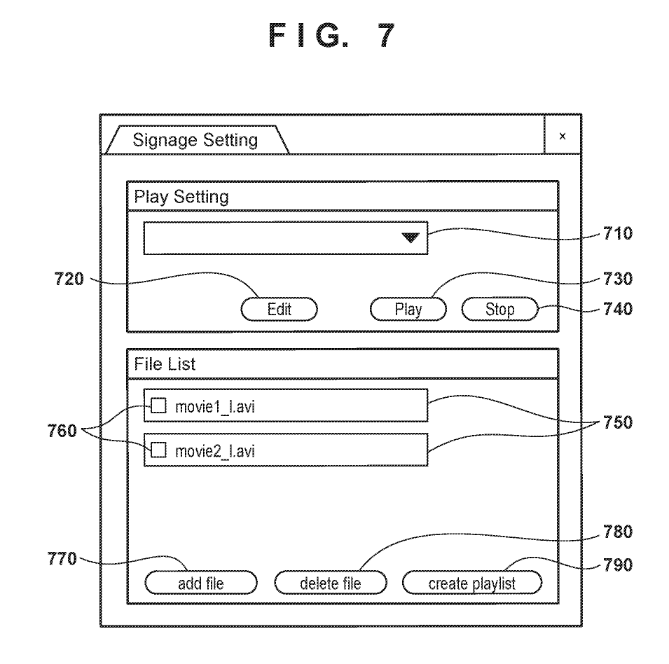

The following describes a signage setting page for transmitting the partial content generated in the partial content generation processing (see FIG. 3) to the projector group constituted in the grouping processing (see FIG. 5), with reference to FIG. 7.

First, the PC 200 displays a browser on the display unit 205 according to the operation of the user. The PC 200 acquires a web page provided by the projector 100a (based on, for example, the URL of the projector 100a or the projector 100b, which is input by the user) and displays the signage setting page on the display unit 205. Note that the following description describes an example of a case where the PC 200 accesses the projector 100a.

FIG. 7 shows an example of the signage setting page of the web page provided by the projector 100a. Reference numeral 710 denotes a playback setting information display area, and playback setting information that sets the combination of playback files, content playback time, and the like, which are saved in the content holding unit 109 of the projector 100a is displayed therein. First, in a state in which the signage setting page is displayed, the playback setting information display area 710 is blank because playback setting information has not been generated. In a case where a plurality of playback setting information is held in the content holding unit 109, the information is selectably displayed in a pull down menu.

Reference numeral 720 denotes an edit button, and it becomes possible to edit the playback setting information when this button is clicked. When the user clicks the edit button 720, the page transitions to an editing page (not shown), where the user can edit the combination of playback files, playback time, and the like, of content that is to be played back, and save the information to the content holding unit 109 as playback setting information.

Reference numeral 730 denotes a play button, and playback of the signage selected in the playback setting information display area 710 is instructed to start when this button is clicked. Reference numeral 740 denotes a stop button, and the signage that is being played back is instructed to stop when this button is clicked.

Reference numeral 750 denotes a file list display area that displays files stored in the content holding unit 109. That is, the user can operate the PC 200 to display files that are inside the projector 100a, and can perform the following operations on each of the files. The example displayed in FIG. 7 shows “movie1_l.avi” and “movie2_l.avi” as already being stored in the content holding unit 109 of the projector 100a. Reference numeral 760 denotes check boxes, and if a check box is checked when a delete file button 780, which will be described below, is clicked, the corresponding file is removed from the content holding unit 109. Reference numeral 770 denotes an add file button, and a selected content file is uploaded from the PC 200 to the projector 100 when this button is clicked.

Reference numeral 780 denotes a delete file button, and files check grammar check box 760 is checked, among the files displayed in the file list display area 750, are deleted when this button is clicked. Reference numeral 790 denotes a create playlist button, and a new play list is created based on the files check grammar check box 760 is checked when this button is clicked.

File Adding Processing

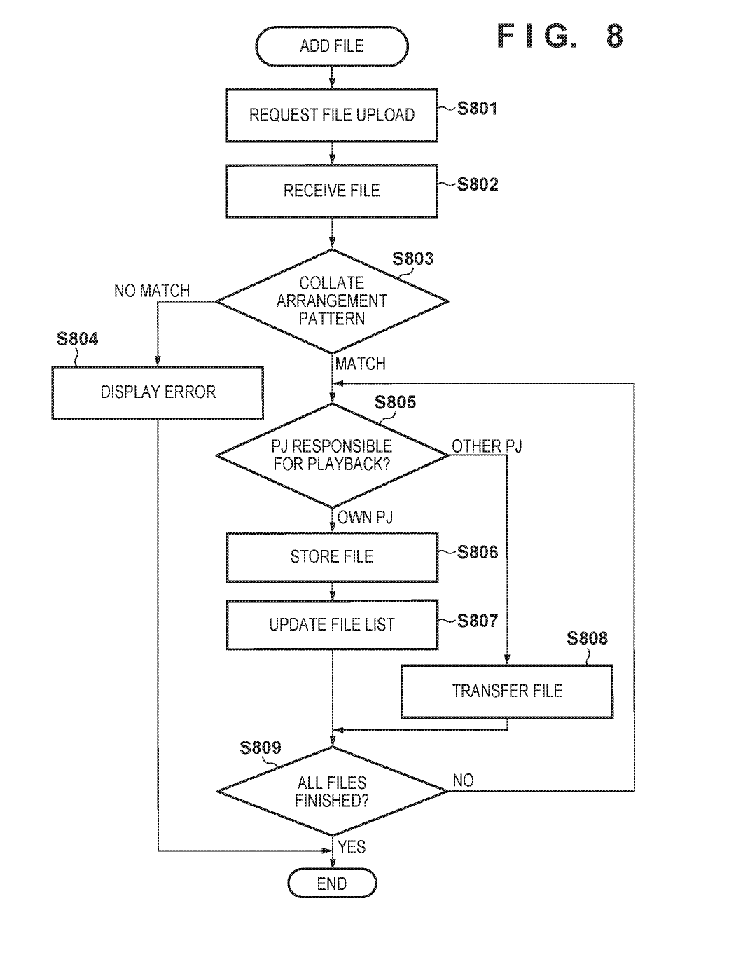

Next, file adding processing will be described with reference to FIG. 8. In the file adding processing, a file stored in the PC 200 is transferred to appropriate projector on the projector side by uploading the stored file to a projector that has layout information. This processing is executed by the CPU 101 of the projector 100a, for example, among the plurality of projectors, and is started when the user clicks the add file button 770 shown in FIG. 7.

In step S801, the CPU 101 issues a file upload request to the PC 200 via the network IF 108. In response to this request, the CPU 201 in the PC 200 displays a file selection window on the display unit 205, and the user selects files of the partial content generated in FIG. 3. Note that the projectors hold the layout information of the projector group set in FIG. 5. For this reason, regardless of which projector is connected to the PC 200, it is possible to select all of the generated partial content files (night_l.avi, night_r.avi) and the content attribute information file in the file selection window. The CPU 201 of the PC 200 transmits the partial content files (night_l.avi, night_r.avi) and the content attribute information file selected by the user, via the network IF 206.

In step S802, the CPU 101 of the projector 100a receives the partial content files (night_l.avi, night_r.avi) and the content attribute information file via the network IF 108, and stores the received files in the RAM 102.

In step S803, the CPU 101, collates the arrangement pattern included in the content attribute information file received in step S802 and the contents of the layout information, and determines if the patterns match. Specifically, the CPU 101 determines if the ‘pattern’ included in the content attribute information shown in FIG. 4E matches the ‘pattern’ included in the layout information shown in FIG. 6C. The CPU 101 transitions to step S805 if the patterns are determined to match. In this case, it is possible to play back files uploaded in the projector group that is currently set. The CPU 101 proceeds to step S804 if they are determined to not match. In step S804, the CPU 101 cannot play back files that are uploaded by the currently set projector group, and thus displays a web page on the PC 200 such that an error message is displayed in the browser, and then ends this processing.

In step S805, the CPU 101 determines the projector that is responsible for the playback of each partial content file that has been uploaded. For example, the CPU 101 first determines whether or not its own projector (self apparatus) is the projector responsible for playback of the uploaded partial content file (night_l.avi). The CPU 101 searches the content of the uploaded attribute information shown in FIG. 4E, and specifies that the projector that is in the first vertical and first horizontal position is the projector responsible for playback, from the description ‘1,1, “night_l.avi”’. Also, the CPU 101 searches the content of the layout information shown in FIG. 6C, and specifies that the projector that is in the first vertical and first horizontal position is the projector with the IP address “192.168.1.1”, from the description ‘1,1, “192.168.1.1”’. At this time, “192.168.1.1” is the IP address of the projector 100a, and as such the CPU 101 determines that the projector responsible for playback of the partial content file “night_l.avi” is its own projector (self apparatus). The CPU 101 proceeds to step S806 if it determines that the projector that is responsible for playback of the partial content of the processing target is its own projector, and proceeds to step S808 if this is not the case.

In step S806, the CPU 101 stores the partial content file “night_l.avi” in the content holding unit 109. Also, in step S807, if the signage setting page is displayed in the PC 200, the CPU updates the file list display area 750 of the web-page. In step S809, the CPU 101 determines if processing has ended for all of the uploaded partial content files. If it is determined that processing has ended for all of the partial content, the CPU 101 ends this processing. On the other hand, if the CPU 101 determines that there are unprocessed partial content files, processing returns to step S805 and processing of the remaining partial content files continues.

The following describes a case in which, in step S805, the target to be processed is the partial content file “night_r.avi”. The CPU 101 searches the contents of the uploaded content attribute information in FIG. 4E, and specifies the projector that is positioned first in the vertical direction and the first in the horizontal direction as being responsible for playback of this partial content, from the description ‘1,2, “night_r.avi”’. Also, the CPU 101 searches the contents of the layout information shown in FIG. 6C, and specifies that the projector positioned first in the vertical direction and the first in the horizontal direction as the projector with the IP address “192.168.1.2”, from 1,1, from the description “192.168.1.2”. At this time, “192.168.1.2” is the IP address of the projector 100b, and as such the CPU 101 determines that the projector responsible for playback of the partial content file “night_r.avi” is not its own projector. As described above, the CPU 101 proceeds to step S808 if it determines that the projector responsible for playback of the partial content to be processed is not its own projector.

In step S808, the CPU 101 transmits partial content that is to be projected by a projector other than its own projector, to that other projector. Specifically, the CPU 101 transfers the partial content file “night_r.avi” to the projector 100b, which is the projector responsible for playback of that partial content (i.e., the projector check grammar IP address is “192.168.1.2”), via the network IF 108. On the other hand, the CPU 101 of the projector 100b stores the partial content to be projected by its own projector in the content holding unit 109. That is, the CPU 101 stores the partial content file received from the projector 100a in the content holding unit 109. The CPU 101 then proceeds to step S809. In this way, each projector that constitutes the projector group is able to hold the partial content file (moving image data) that the projector is responsible for playing back.

Note that the embodiment above is described using a case in which moving image content is displayed by the projectors as an example, but it can also be applied in the same manner in a case where still image content is displayed.

Also, the above describes an example in which partial content is generated from the whole content with use of an application of the PC 200. However, the whole content may be uploaded from the PC 200 to a partial content information input page provided by the web server of the projector 100a, for example, and the projector 100a may generate the partial content and the content attribute information.

Furthermore, the partial content files and the content attribute information file have been described as being separate files, but the content attribute information may be incorporated as header information of the partial content to form of a single file.

Also, in the example above, the user edits the playback setting information illustrated in FIG. 7, and configures settings for playing back specified moving image data from a specified time on the projector 100a, for example, included in the projector group. Thus, the projector 100a, having detected that the specified time has arrived, synchronizes with the other projectors and starts playback of the instructed moving image data. At the same time, the other projectors start playing back their moving images that are associated with the specified moving image data. The moving image data for the respective areas for which the projectors are responsible is thereby played back in synchronization, and multi-projection moving image playback can be realized.

As described above, in the above embodiment, a plurality of partial content and content attribute information for use in multi-projection are acquired from a PC by a predetermined projector among a plurality of projectors and transmitted to the appropriate projectors responsible for playing back the respective partial content. At this time, the predetermined projector determines which projector is responsible for projecting each partial content based on the content attribute information and the layout information, and transmits the partial content to the appropriate projector. By doing so, when projection of content as a whole is constituted by projection of a plurality of projectors, an external device such as a PC that is connected to the projectors does not require a special application, and content can be transmitted to the projectors with a simple procedure. That is, in a case where projection of content as a whole is constituted by projection of the plurality of projectors, the appropriate partial content can easily be distributed to the projectors.

### Second Embodiment

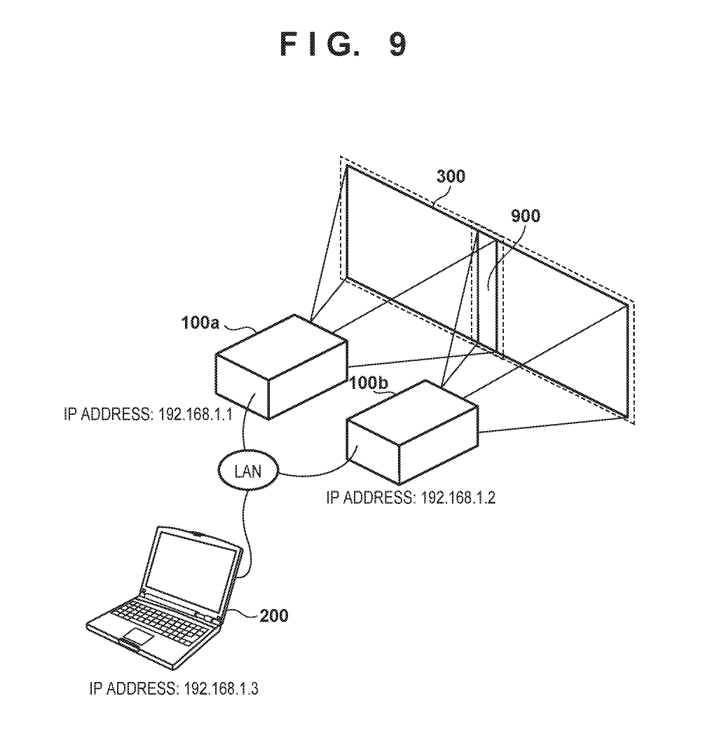

The following describes a multi-projection system according to the second embodiment. FIG. 9 shows an example of the multi-projection system according to the second embodiment. Different to the first embodiment, the second embodiment is configured such that a part of the projection areas of the projectors 100a and 100b overlap (a projection area A of the projector 100a and a projection area B of the projector 100b constitute an overlap area 900). In order to make such a configuration possible, coordinate values are added to the content attribute information and layout information, as will be described later.

Partial Content Generation Processing

In the processing for generating partial content for multi-projection use that is executed by the PC 200, the flow of processing is practically the same as the first embodiment, but the partial content information input window and the content attribute information to be generated are different. For this reason, the description will focus on the differing points related to steps S301, S303 and S304, and, with regard to redundant description, the same reference numerals are given and description is omitted as appropriate.

FIG. 100A shows an example of a partial content information input window 1030 according to the present embodiment, displayed on the display unit 205 by a CPU 201, in step S301. The partial content information input window 1030 has edge blend width input fields 1010 and 1020. In the illustrated example, because 1×2 (a layout with two projectors lined up horizontally) is selected in an arrangement pattern pull down menu 420, the edge blend width input field 1020 in the vertical direction is grayed out. “500” pixels, for example, indicating the overlap width of the partial content has been input in the input field 1010 of the edge blend width in the horizontal direction. Note that even in the case of an arrangement pattern with three or more projectors in one direction, a common edge blend width is set in the same direction for the sake of simplicity, but different values may be set for the edge blend width between the first and second projectors and for the edge blend width between the second and third projectors.

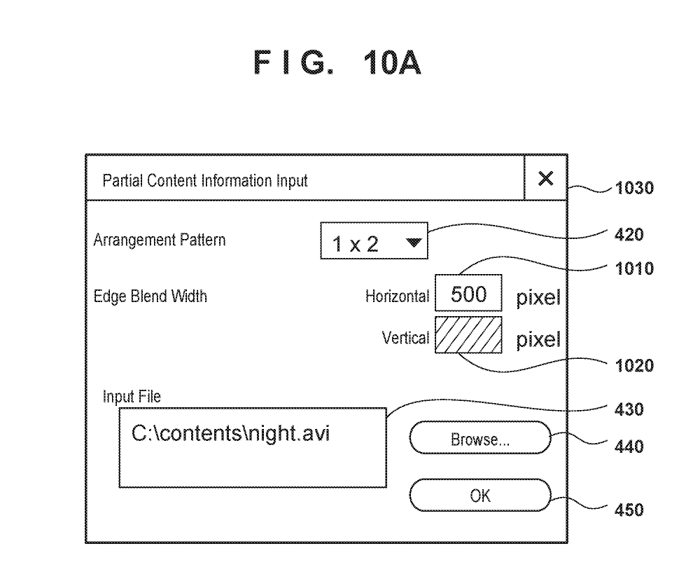

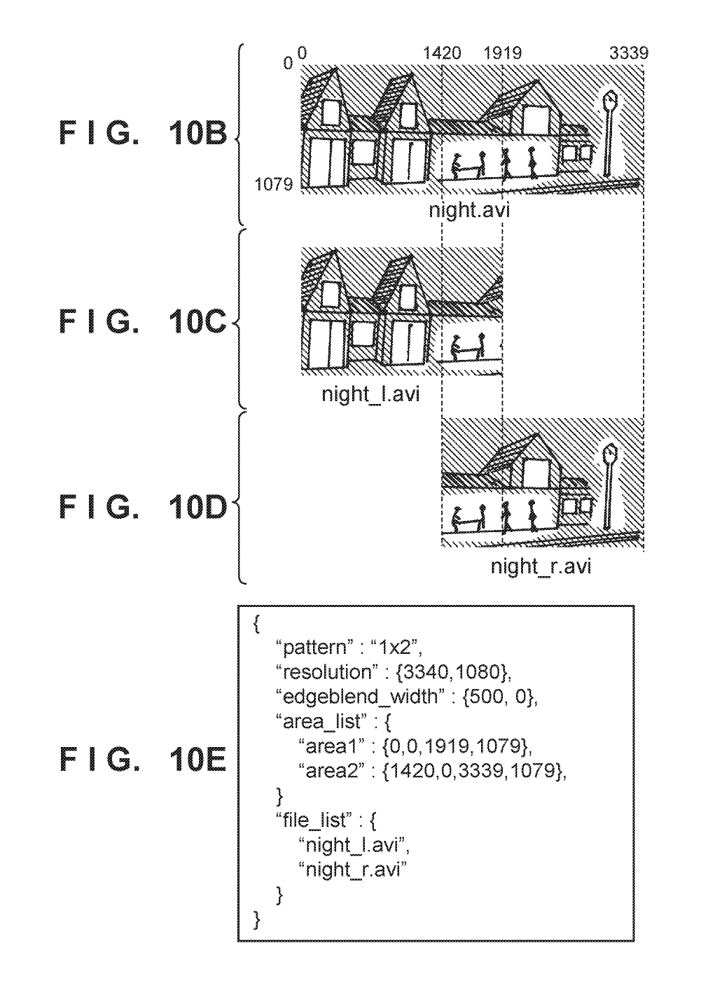

FIGS. 10B to 10D show an example of the whole content read out by the CPU 201 in step S302, and an example of the partial content generated by the CPU 201 in step S303. The whole content is the same as FIG. 4B, but a pixel count (3340 pixels wide, 1080 pixels high) from the top left corner of the main position is shown for this description.

In step S303, the CPU 101, in accordance with the edge blend width in the horizontal direction set in step S301, generates partial content such that night_l.avi and night_r.avi have an overlapping portion of 500 pixels. The CPU 101 stores an area of 1920 pixels of horizontal width obtained by adding the left half of the whole content and half of the 500 pixel edge blend width, in the ROM 203 as the partial content (night_l.avi) for use in the left hand side of the screen. In the same manner, the CPU 101 stores an area of 1920 pixels of horizontal width obtained by adding the right half of the whole content and half of the 500 pixel edge blend width, in the ROM 203 as the partial content (night_r.avi) for use in the right hand side of the screen.

Next, FIG. 10E shows an example of the content attribute information file that is generated by the CPU 201 in step S304. “resolution” showing the resolution of the whole content, “edgeblend_width” showing the edge blend width and “area_list” showing the coordinates of the whole content and the partial content have been added to FIG. 4E. “resolution” is the 3340×1080 resolution of the whole content night.avi. “edgeblend_width” is the edge blend width in the vertical and horizontal directions and the edge blend width in the horizontal direction is 500. The edge blend width in the vertical direction has, for example, a dummy value 0 because this value does not apply in the case where the arrangement pattern is 1×2. “area_list” shows that “area1”, which is the first area of partial content, has coordinates (0, 0) to (1919, 1079), with the origin being in the upper left of the whole content. Also, “area_list” shows that “area2”, which is the second area of partial content, has coordinates (1420, 0) to (3339, 1079). The order of the areas included in “area_list” correspond to the order of files in “file list”, which is included after “area_list”. In the example in FIG. 10E, “area1” corresponds to “night_l.avi”, and “area2” corresponds to “night_r.avi”.

Note that in the example of the content attribute information in the present embodiment, information showing position information is not included in “file_list”. This is because the correspondence between “file_list” and “area_list” is known, and position information can be calculated.

Projector Grouping Processing

The following describes the processing for grouping projectors for use in multi-projection. The flow of processing is practically the same that as shown in FIG. 5, but because step S501 and step S503 differ in terms of using the edge blend setting menu, that difference will be described.

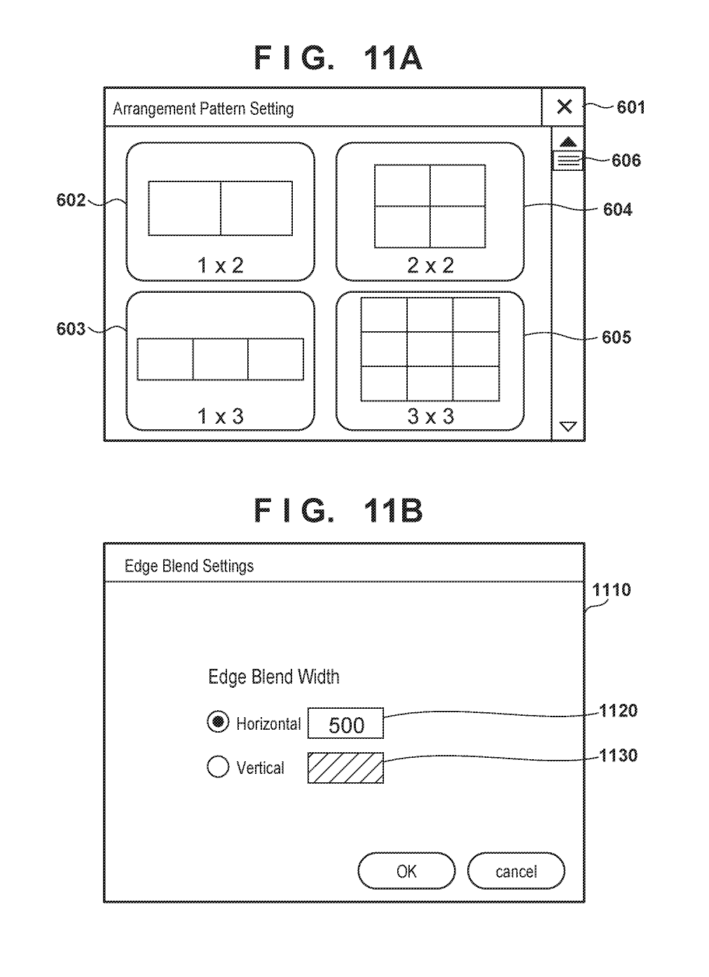

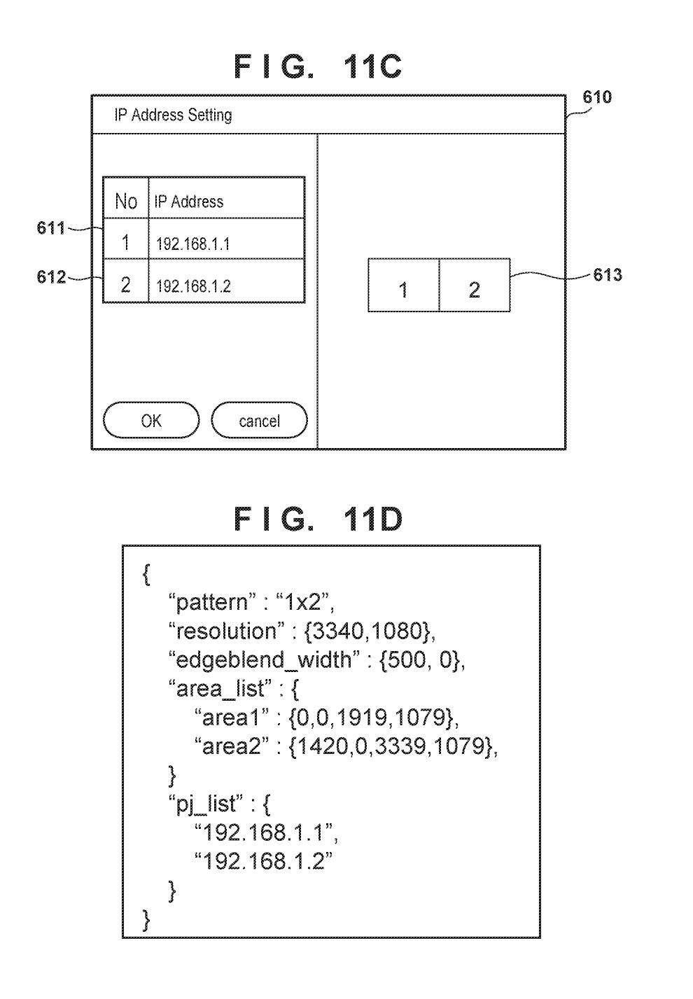

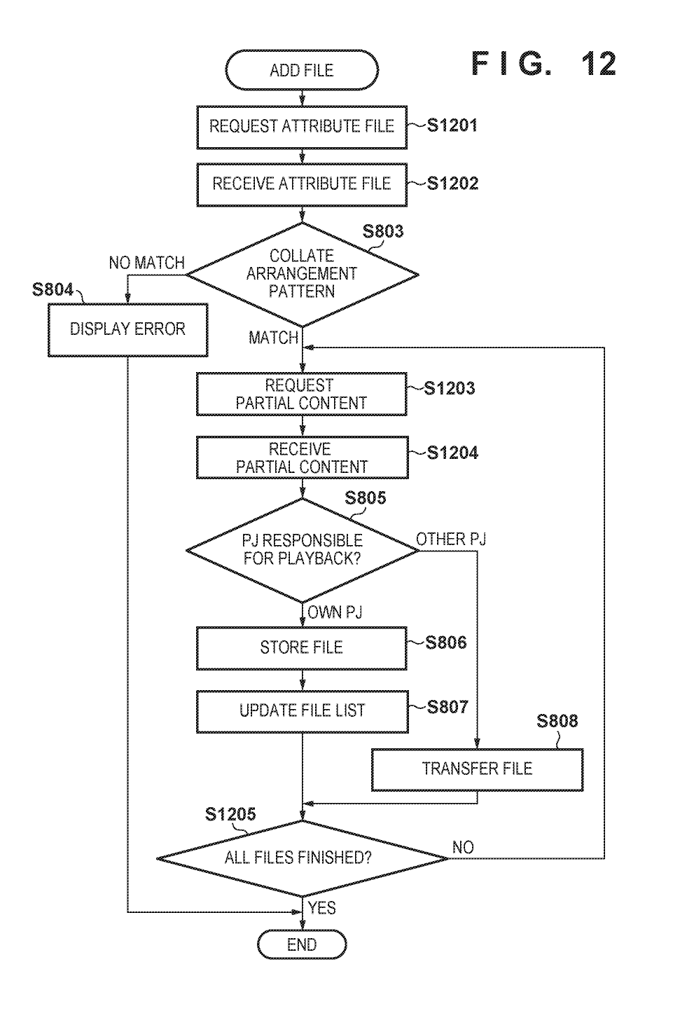

In step S501, after selecting the arrangement pattern in the arrangement pattern setting menu (as in FIG. 6A) shown in FIG. 11A, the CPU 101 of the projector displays a menu for setting the edge blend width. The CPU 101 stores the edge blend setting menu in the VRAM 106, and instructs the projection control unit 105 to project the edge blend setting menu via the projection unit 104. Therefore, the CPU 101 monitors user operations made on the arrangement pattern settings menu via the operation unit 107, and waits for the arrangement pattern to be determined. FIG. 11B shows an example of an edge blend settings menu 1110 according to the present embodiment. In this example, assuming the case where an arrangement pattern of 1×2 (an arrangement pattern 602 in which two projectors are lined up horizontally) is selected in FIG. 11A, the CPU 101 grays out an input field 1130 of the edge blend width in the vertical direction. On the other hand, the input field 1120 of the edge blend width in the horizontal direction displays 500 pixels. Even in the case of an arrangement pattern with three or more projectors in one direction, these edge blend widths have a common value in the same direction, in the same manner as FIG. 10A, but different values may be set for the edge blend width between the first and second projectors and for the edge blend width between the second and third projectors.

Next, FIG. 11D shows an example of a layout information file that is generated by the CPU 101 in step S503. In the examples of the present embodiment, “resolution” showing the resolution of the whole content, “edgeblend_width” showing the edge blend width and “area_list” shows the coordinates of the whole content and the partial content have been added. These items are the same as the corresponding elements in the content attribute information shown in FIG. 10E. The order of the areas included in “area_list” corresponds to the order of files in “pj_list”, which is included after the area list. Also, the reason for information that shows position information not being included in “pj_list” is similar to the content attribute information shown in FIG. 10E. That is, the correspondence between “pj_list” and “area_list” is known, and position information can be calculated.

File Adding Processing

The flow related to the file adding processing according to the present embodiment is also practically the same as the other embodiments, but depending on the layout information and the content attribute information, the specific contents of the comparison of arrangement patterns (step S803) and the determination of projectors responsible for playback (step S805) are partially different to the first embodiment.

In step S803, the CPU 101, in addition to collating the “pattern”, determines if the elements included the content attribute information file shown in FIG. 10E respectively match the elements included in the layout information file shown in FIG. 11D. For example, the CPU 101 determines if “resolution”, “edgeblend_width”, and “area_list” each respectively match between both files.

In step S805, the CPU 101 determines the projectors responsible for playback based on coordinate values that include the uploaded content attribute information file and the layout information file. For example, first the CPU 101 performs determination for the uploaded partial content file “night_l.avi”. The CPU 101 searches for “file_list” in the uploaded content attribute information file shown in FIG. 100E and finds out which number “night_l.avi” is included as in the order of files. “night_l.avi” is included as number one, and thus corresponds to the area “area1” which is likewise included as number one in “area_list”, and thus it is revealed that the coordinates are (0, 0) to (1919, 1079). Next, the CPU 101 finds out which number the same coordinates, (0, 0) to (1919, 1079), are included as in the order of areas from the layout information file shown in FIG. 11D. The coordinates of“area1”, which are included as number one, match, and thus it is revealed that “192.168.1.1” included as number one in “pj_list” is the projector responsible for playback. Because it is known that “192.168.1.1” is the IP address of the projector 100a, the CPU 101 determines that its own projector is the projector responsible for playing back “night_l.avi”.

Furthermore, the CPU 101, in a similar manner for the second partial content file “night_r.avi”, specifies “192.168.1.2” as the projector responsible for playback, and determines that its own projector is not the projector responsible for playing back “night_r.avi”. The CPU 101 performs other processing in a similar manner to the first embodiment, and then ends this processing.

As described above, the content attribute information file and the layout information file of the present embodiment include coordinate values for use in multi-projection. By doing so, is becomes possible to set projection by the projectors in greater detail, and projector positioning and partial content dividing can be performed with more flexibility.

### Third Embodiment

Furthermore, a third embodiment will be described. In the present embodiment, in the file upload from the PC 200, first the content attribute information file is uploaded and then the partial content files are uploaded one by one.

FIG. 12 shows a series of operations in the file adding processing according to the present embodiment. Note that the CPU 101 executes this processing when the user clicks the add file button 770, which is shown in FIG. 7. Processing that is the same as FIG. 8 is given the same reference numerals and description thereof is omitted.

In step S1201, the CPU 101 transmits a content attribute information file upload request to the PC 200 via the network IF 108. In response to this, the CPU 201 of the PC 200, in the same manner as the first embodiment, displays the file selection window on the display unit 205, and when the user selects partial content files, only the corresponding content attribute information file is transmitted to the projector 100a. In step S1202, the CPU 101 of the projector 100a receives the content attribute information file via the network IF 108.

In step S1203, because the CPU 101 has determined that the arrangement pattern in step S803 matches, the CPU 101 transmits a partial content file upload request to the PC 200 via the network IF 108. In response to this, the CPU 201 of the PC 200 extracts one file from the partial content files that have been selected by the user and transmits the extracted file to the projector 100a. In step S1204, the CPU 101 of the projector 100a receives the partial content files from the PC 200 via the network IF 108. The CPU 101 then executes the processing of steps S805 to S808.

In step S1205, the CPU 101 determines whether processing of all of the partial content files has ended. The determination in the present embodiment is performed by determining whether or not reception of all of the files included in the content attribute information file received in step S1202 has ended. The CPU 101 ends this processing if reception of all the partial content files has ended, or returns to step S1203 if there is an unreceived partial content file. The CPU 101 performs other processing in the same manner as in the first embodiment, and then ends this processing.

As described above, in the present embodiment, the CPU 101 receives the partial content files one by one after having received the attribute file beforehand, and if the received file is a file to be played back by its own projector, that file is stored in the content holding unit 109. Also, if the partial content file is a file to be played back by another projector, that file is transmitted to that other projector. By doing so, it is possible to limit the number of partial content files that are stored in the RAM 102 (usually one file in the example above). Accordingly, even in a case where the size of the RAM 102 of the projector 100 is limited, it becomes possible to distribute partial content files of very large size to the projectors, and thus it is possible to realize a multi-projection system that uses moving image data of large size.

### Other Embodiments

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-217510, filed Nov. 10, 2017 which is hereby incorporated by reference herein in its entirety.

What is claimed is:

1. A projection apparatus that projects one of a plurality of partial content in order to constitute projection of a whole content by combining projection of the plurality of partial content, comprising:
a communication unit configured to communicate with other projection apparatus;
an acquisition unit configured to acquire the plurality of partial content to be used in the projection of the whole content; and
a control unit configured to control distribution of the plurality of partial content, based on content attribute information that indicates a combination of the plurality of partial content for constituting the projection of the whole content, and layout information that indicates a combination of a plurality of projection apparatuses for constituting the projection of the whole content,
wherein the control unit controls the communication unit to transmit partial content, out of the plurality of partial content, that is to be projected by the other projection apparatus to the other projection apparatus.

2. The apparatus according to claim 1, wherein the control unit includes a determining unit configured to determine, for each of the plurality of partial content, whether the partial content is partial content to be projected by the self apparatus or whether the partial content is partial content to be projected by the other projection apparatus, based on the content attribute information and the layout information.

3. The apparatus according to claim 2, wherein the control unit stores partial content determined to be the partial content to be projected by the self apparatus in a recording unit of the projection apparatus.

4. The apparatus according to claim 1, further comprising a layout generation unit configured to generate layout information, based on a user operation for setting an arrangement or a position of the projection apparatuses for projecting the plurality of partial content.

5. The apparatus according to claim 1, wherein the layout information includes an arrangement or a position of the projection apparatuses for projecting the plurality of partial content, and information for identifying the projection apparatuses.

6. The apparatus according to claim 5, wherein the information for identifying the projection apparatuses is an IP address of the projection apparatuses.

7. The apparatus according to claim 1, wherein the communication unit further receives the plurality of partial content from an external apparatus, and
wherein the acquisition unit acquires the plurality of partial content via the communication unit.

8. The apparatus according to claim 7, wherein the communication unit further receives the content attribute information from the external apparatus.

9. The apparatus according to claim 1, wherein the communication unit further receives the whole content from an external apparatus, and
wherein the acquisition unit acquires the plurality of partial content from the received whole content.

10. The apparatus according to claim 9, further comprising a server unit configured to control provision of display information for display by a predetermined application of the external apparatus, and control reception of a user operation performed for the display information that is displayed by the predetermined application,
wherein the acquisition unit acquires the content attribute information and acquires the plurality of partial content from the received whole content, based on the user operation that is acquired by the server unit.

11. The apparatus according to claim 1, wherein the content attribute information includes an arrangement of the partial content for projecting the plurality of partial content, and information for identifying partial content that corresponds to the arrangement.

12. The apparatus according to claim 1, wherein the content attribute information includes a position onto which to project the partial content for projecting the plurality of partial content, and information for identifying the partial content that corresponds to the position.

13. The apparatus according to claim 1, wherein the control unit further controls the communication unit to transmit the layout information to the other projection apparatus.

14. A control method of a projection apparatus that projects one of a plurality of partial content in order to constitute projection of a whole content by combining projection of the plurality of partial content, and that has a communication unit configured to communicate with other projection apparatus, the method comprising:
acquiring the plurality of partial content to be used in the projection of the whole content; and
controlling distribution of the plurality of partial content, based on content attribute information that indicates a combination of the plurality of partial content for constituting the projection of the whole content, and layout information that indicates a combination of a plurality of projection apparatuses for constituting the projection of the whole content,
wherein, in the control, the communication unit is controlled to transmit partial content that is to be projected by the other projection apparatus, out of the plurality of partial content, to the other projection apparatus.

15. A projection system comprising a transmission apparatus and a projection apparatus that projects one of a plurality of partial content in order to constitute projection of a whole content by combining projection of the plurality of partial content,
the projection apparatus comprising:
a communication unit configured to communicate with the transmission apparatus and other projection apparatus;
an acquisition unit configured to acquire the plurality of partial content to be used in the projection of the whole content from the transmission apparatus via the communication unit; and
a control unit configured to control distribution of the plurality of partial content, based on content attribute information that indicates a combination of the plurality of partial content for constituting the projection of the whole content, and layout information that indicates a combination of a plurality of projection apparatuses for constituting the projection of the whole content,
wherein the control unit controls the communication unit to transmit partial content that is to be projected by the other projection apparatus, out of the plurality of partial content, to the other projection apparatus, and
the transmission apparatus comprising:
a generation unit configured to generate the plurality of partial content from the whole content, and to generate content attribute information; and
a transmission unit configured to transmit the plurality of partial content and the content attribute information to the projection apparatus.
